(19) United States
(12) Patent Application Publication
(10) Pub. No.: US 2010/0096562 A1
(43) Pub. Date: Apr. 22, 2010

(54) WIREGRID WAVEGUIDE

(75) Inventors: Derk J.W. Klunder, Eindhoven (NL); Maarten M.J.W. Van Herpen, Eindhoven (NL); Marcus A. Verschuuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,834

(22) PCT Filed: Dec. 17, 2007
(86) PCT No.: PCT/IB2007/055160

§ 371 Date: Jun. 18, 2009

(30) Foreign Application Priority Data
Dec. 21, 2006 (EP) 06126842.1

(51) Int. Cl. G01N 21/64; G02B 6/12

(52) U.S. Cl. 250/459.1; 385/14; 250/458.1

(57) ABSTRACT

There is provided a wave guide comprising: a wave guiding medium, having an index of refraction and provided between first and second wave propagating planar structures at least said first planar structure comprises a plurality of slitted-apertures defining a length axis of the first reflective structure; the slitted apertures constructed and arranged to reflect a R-polarized component of said radiation oriented parallel to said length axis; and wherein said first planar structure is arranged between said wave guiding medium and an adjacent medium having an index of refraction equal or larger than the wave guiding medium. In one aspect of the invention, a waveguide is proposed to limit an excitation region wherein luminophores are excited; substantially independent from the surrounding media of the waveguide. Preferentially, the waveguide is used in a luminescence sensor.

### FIELD OF THE INVENTION

The invention relates to the field of a method of propagating a polarized wave of radiation in a wave guiding medium.

### BACKGROUND OF THE INVENTION

Waveguides are used for a variety of purposes. Essentially, a waveguide confines radiation to travel substantially guided by the wave guide, so that a bounded region is obtained where the radiation is present. In “Fabrication of a new broadband waveguide polarizer with a double-layer 190 nm pe-riod metal-gratings using nanoimprint lithography”; Jian Wang; Schablitsky S; Zhaon-ing Yu; Yu Wei; Chou S Y, Journal of Vacuum Science & Technology B (Microelec-tronics and Nanometer Structures), VOL 17, NR 6, PG 2957-2960, ISSN 0734-211X, a waveguide configuration is proposed for a waveguide having a waveguide core and top and bottom cladding layers. A wiregrid is attached to the core. The cladding layers are comprised of a medium having a refraction index smaller than the waveguide core, allowing a conventional propagation mode of radiation by total internal reflection.

### SUMMARY OF THE INVENTION

A desire exists to provide a waveguide, wherein the cladding layers, herein further referenced as adjacent media, are not limited to materials having a refractive index smaller than the waveguide core to utilize the total internal reflection principle, for example, to provide the waveguide in fluid media for biosensing purposes. Accordingly, in one aspect of the invention, there is provided a wave guide comprising: a wave guiding medium defining a diffraction limit for a wave to be guided in said wave guiding medium, having an index of refraction and provided between first and second wave reflecting planar structures wherein at least said first planar structure forms a plurality of apertures having a smallest in plane aperture dimension smaller than the diffraction limit; and wherein said first planar structure is arranged between said wave guiding medium and an adjacent medium having an index of refraction equal or larger than the wave guiding medium.

In another aspect of the invention there is provided a method of detecting a presence of a luminophore in a wave guide, comprising: propagating excitation radiation in a wave guide comprising a wave guiding medium defining a diffraction limit for a excitation radiation to be guided in said wave guide, having an index of refraction and provided between first and second reflective planar structures constructed and arranged to reflect said wave in said wave guiding medium; at least one of said planar structures comprising an aperture defining a smallest in plane dimension smaller than the diffraction limit; providing a luminophore in a said wave guiding medium, the luminophore being excitable by said excitation radiation to emit luminescent radiation; and detecting said luminescent radiation by a detector.

In one aspect of the invention, a waveguide is proposed to limit an excitation region wherein luminophores are excited; substantially independent from the surrounding media of the waveguide. Preferentially, the waveguide is used in a luminescence sensor, said waveguide being permeable for a medium feed flow transverse to said planar structure; the medium comprising a luminophore; and said detector arranged to receive luminescent radiation from said luminophore from a direction transverse to said planar structure. These and other aspects of the invention will be apparent from and elucidated with reference to the embodiment(s) described hereinafter.

### BRIEF DESCRIPTION OF THE DRAWINGS

FIG. 1 illustrates a basic embodiment in cross sectional view, of a wave guide according to an aspect of the invention;

FIG. 2 illustrates a graph showing a reflection intensity and phase shift for angles of incidence, for the wave guide according to FIG. 1 when surrounded by water;

FIG. 3 illustrates a modal intensity distribution of waveguide according to

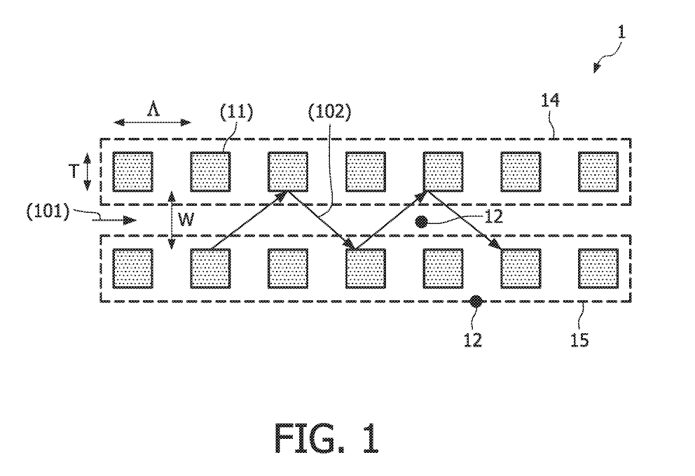

FIG. 1;

FIG. 4 illustrates a dependence of decay length of the fundamental mode on a wave guide width;

FIG. 5 illustrates a schematic graph showing a first embodiment of a luminescence sensor according an aspect of the invention;

FIG. 6 illustrates a schematic graph showing a second embodiment of a luminescence sensor according an aspect of the invention;

FIG. 7 illustrates a schematic graph showing a third embodiment of a luminescence sensor according an aspect of the invention;

FIG. 8 illustrates a schematic graph showing a fourth embodiment of a luminescence sensor according an aspect of the invention;

FIG. 9 schematically illustrates a top view respectively a cross sectional view of waveguide embodiment comprising a confining structure;

FIG. 10 shows a schematic side view of a supporting structure for a waveguide embodiment; and

FIG. 11 shows a top view of a waveguide comprising the supporting structure of FIG. 10.

### DETAILED DESCRIPTION OF EMBODIMENTS

This invention proposes a waveguide as an attractive means for localized excitation of luminophores and natural separation between excitation radiation and emission radiation, the latter radiation also referenced as luminescence. The radiation is typically light in the visible or near infrared region of the electromagnetic spectrum. As an example, excitation radiation and luminescence (e.g., fluorescence) is provided in wavelengths of about 300 to 1000 nm. In one embodiment the waveguide comprises of a pair of slitted planar structures, also referenced as wiregrids, at a spacing of typically 100 nm up to a few microns. Accordingly, a polarization selective wave guide concept can be provided. The concept can be also applied for other applications where it is desired that the light is confined in a material having a lower index of refraction than its environment, like a fluid.

Advantages of this concept may include the following:
1) The waveguide according to the invention, in a preferred embodiment, comprises wiregrids that do not transmit the TE polarized component of excitation radiation that is oriented parallel to a length axis of the wiregrids, in the remainder shortly referenced as R-polarized excitation radiation.
2) In one embodiment, a TM polarized part (that is, the part orthogonal to the R-polarized part) of the generated luminescence/emission, also referenced as T-polarized luminescence can escape from the waveguide via the wiregrids since the wiregrids are substantially transparent for such a polarized component: excellent spatial separation between excitation and emission. R-polarized luminescence can be detected via the waveguide.
3) In one embodiment, the waveguide system may be open for fluids flowing through the upper and lower wiregrids, making the concept suitable for vertical flow-through approaches.
4) In one embodiment, the spacing between the planar structures may form a fluid channel by itself, which confines a fluid flow between the planar structures.
5) In one embodiment the wave-guide can be stacked in between a pair of mirrors which may enhance the excitation field as well.
6) In one embodiment one may use a layer with a lower index than the fluid for providing total internal reflection at the interface of this medium with the fluid (e.g., TEFLON AF or meso-porous silica have an index of refraction lower than water) and in this way create confinement of the wave guide mode in the direction parallel to the wiregrids.

Further advantages of the inventive principle may include:

1. Automatic separation between excitation and luminescence light in both the upwards and downwards directions, seen relative to a plane defined by the wave guide planar structure; which may result in suppression of the background radiation generated by the excitation radiation.

2. Excitation of luminophores may be provided localized; typically, within the wave guide structure.

3. An open structure may be provided, which may be suitable for flow through applications and addition of structures for specific binding.

In FIG. 1, a cross sectional view is provided of a wave guide structure 1 illustrating R-polarized excitation radiation 101 having a TE-component oriented essentially along a length axis of the wave guide structure 1, a “leaky” (in the sense that a very small fraction—typically about 0.1% or less—is transmitted by the reflecting planar structures 1) optical waveguide system is provided that confines the excitation radiation 101 between the planar structures 1. Preferably, the wave guide structure 1 is an open structure (i.e., suitable for flow through separation) for the fluid and is suitable for detection of the luminescence in both the upwards and downwards direction (see FIG. 5-FIG. 8).

In particular, the wave guide structure 1 is surrounded by a wave guiding medium 12 defining a diffraction limit for a wave 101 to be guided in said wave guiding medium 12. The wave guide structure 1 is provided by top and bottom wave reflecting planar structures 14, 15 forming a grid of wires 11 and schematically shown to reflect rays of light 102. In the embodiment as shown, the wires 11 are provided freestanding with the long direction into the plane of the paper. The wiregrids have a period Λ and thickness T. The parallel planar structures have identical orientation and are at a mutual distance W also referred to as the ‘waveguide width’.

The planar structures 14, 15 forms a plurality of apertures. A smallest in plane aperture dimension is defined as a spacing distance between the wiregrids 11 and is smaller than the diffraction limit. For good reflection the opening between the sections of material is preferably below 80% of the diffraction limited opening.

Although the embodiment show a single surrounding medium 12 to be in- and outside the wave guide structure 1, also, according to the invention, a wave guiding medium provided inside and an adjacent medium provided adjacent said waveguide may be utilized, the adjacent medium in particular having an index of refraction equal or larger than the wave guiding medium.

In order to explain the working principle of the wire grid wave guide 1 first consider the reflection of a wire grid illuminated with R-polarized light. Proper operation requires that all orders except the zero-order diffraction are evanescent for all angles of incidence. This can be achieved by a proper choice of the grating period (Λ):

$$Λ < {Λ}_{min} ≡ \frac{λ}{2 \cdot {n}_{medium}} \qquad ( 1 )$$

with λ the wavelength in vacuum and n_{medium} the refractive index of the medium in front of the wire grid. Here, Λₘᵢₙ is defined as the diffraction limit, which may typically be defined as a wavelength in the medium of twice the grating period.

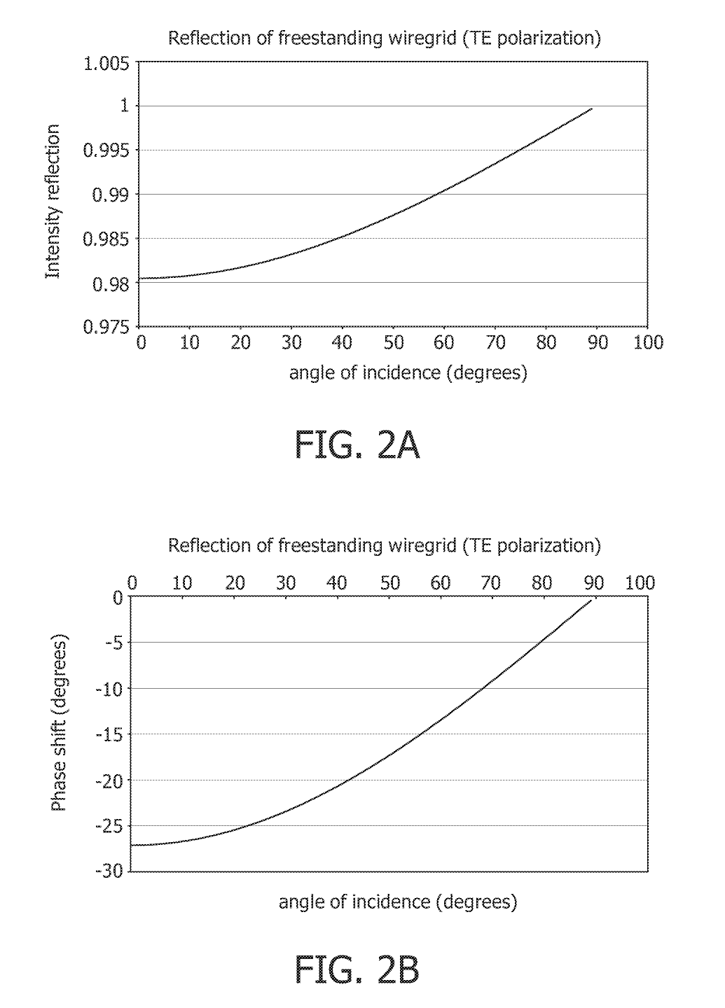

As an example FIG. 2A considers a diagram showing a reflection efficiency for varying angles of incidence, in a configuration according to FIG. 1, for a free-standing wiregrid 1 surrounded by water 12 having a refractive index n_{medium}=1.3:

| | |
|---|---|
| Material of wires | Aluminium (Al) index of refraction: n ~0.162-j*7.73 |
| Period (Λ) | 200 nm < Λmin = 250 nm |
| Duty cycle | 0.5 (opening of 100 nm) |
| Thickness (T) | 100 nm |
| Wavelength | 650 nm |

Typically, the efficiency varies between 0.98 for zero degree incidence, to almost 1 for 90 degree incidence (relative to a normal of a plane of incidence).

In addition, FIGS. 2A and 2B show a calculated intensity reflection and phase shift for reflection of R-polarized on the above described wire grid. A high reflection of the R-polarized light is shown for all angles of incidence with increasing reflection for more grazing angles of incidence. It is found that the transmission for R-polarized light is lower than 0.002%.

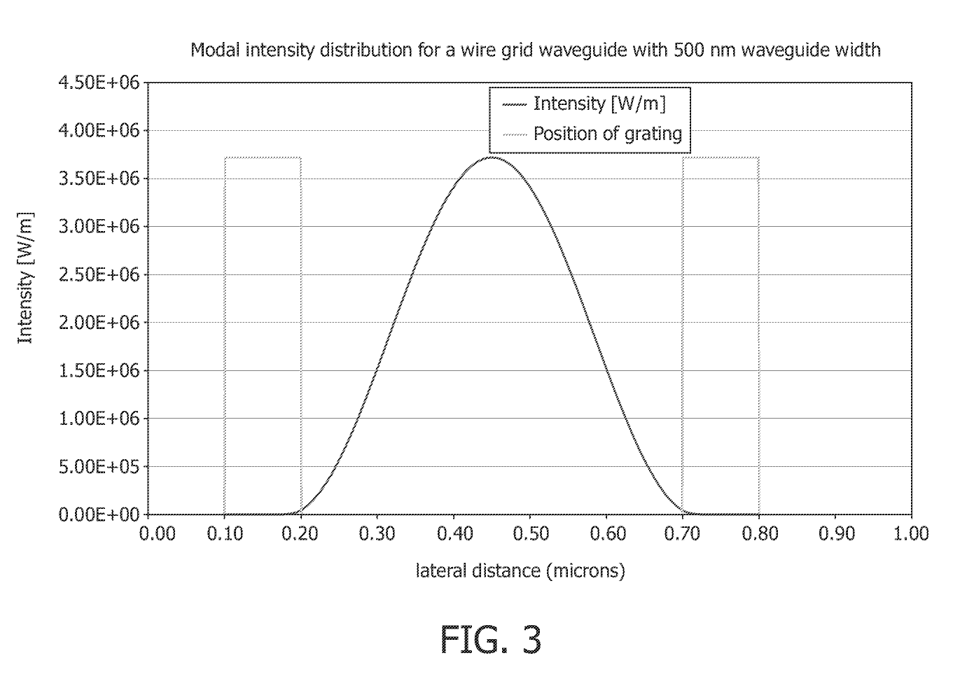

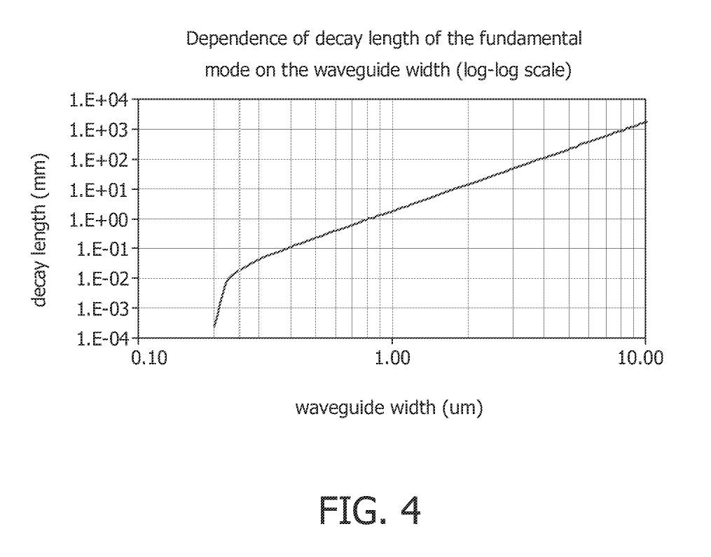

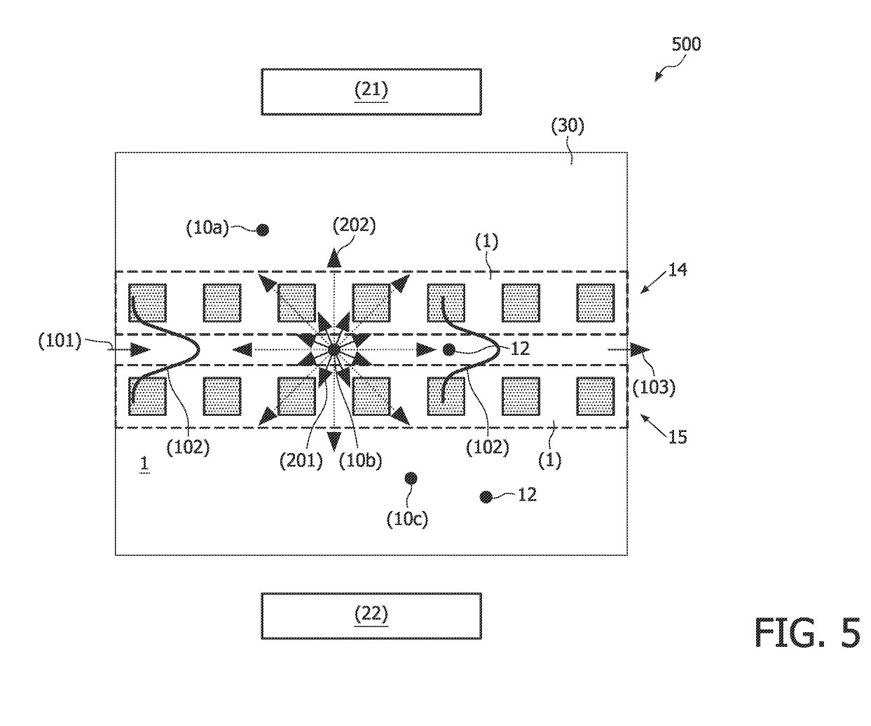

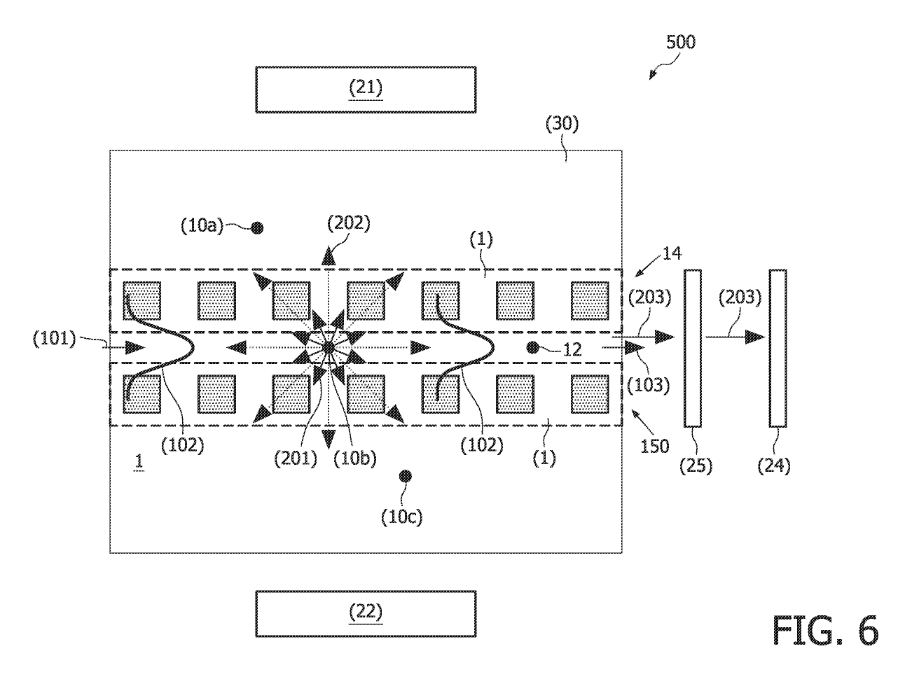

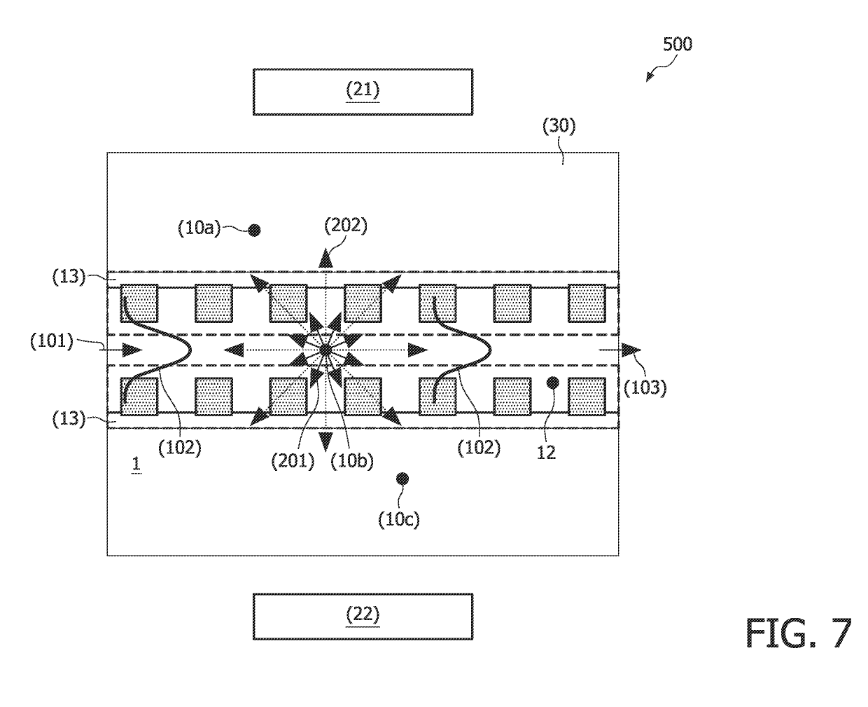

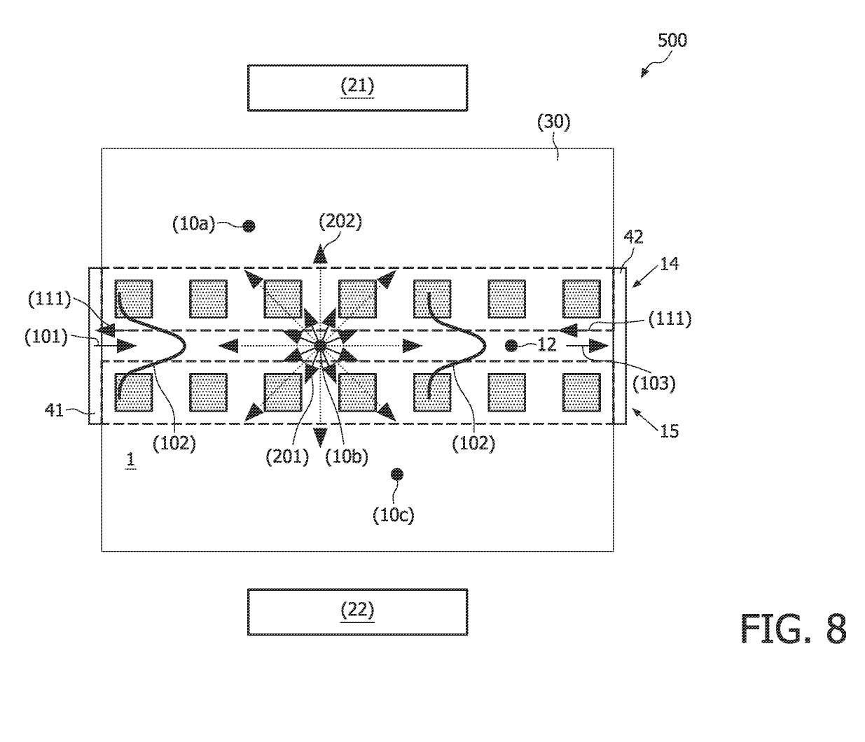

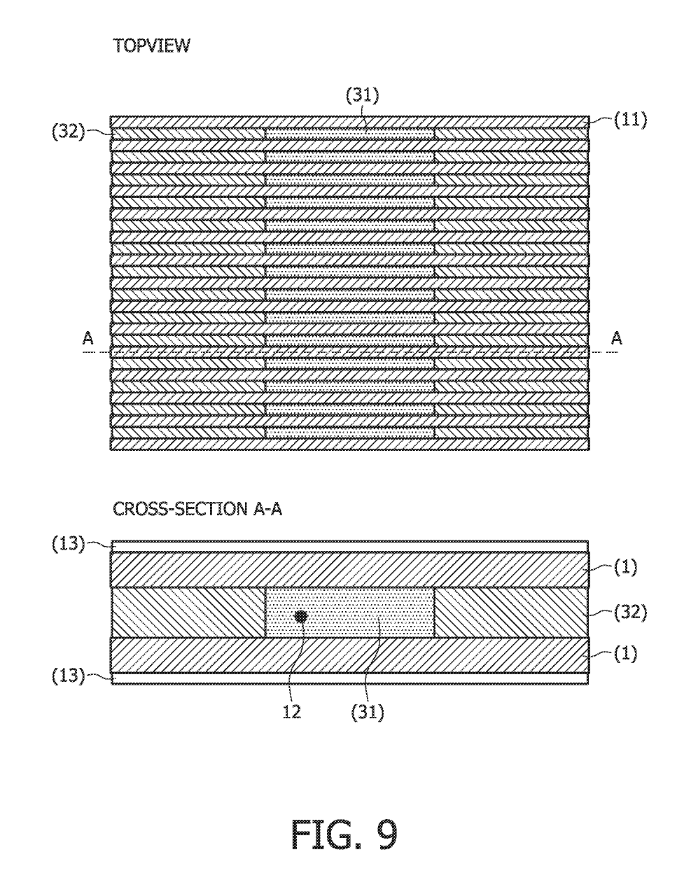

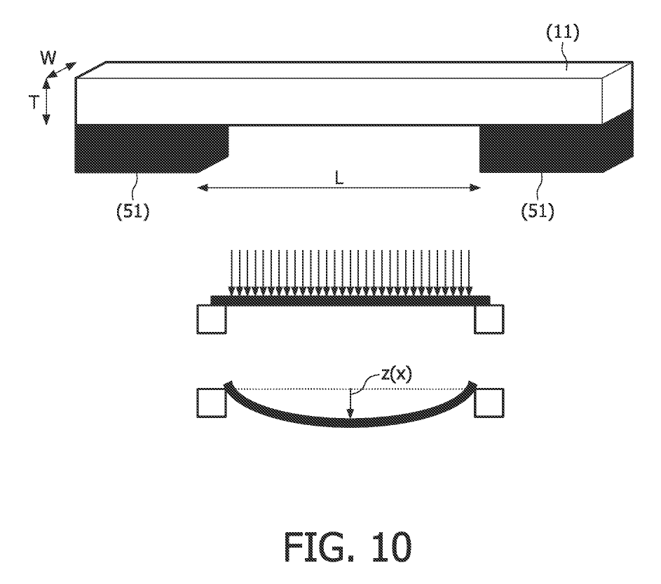

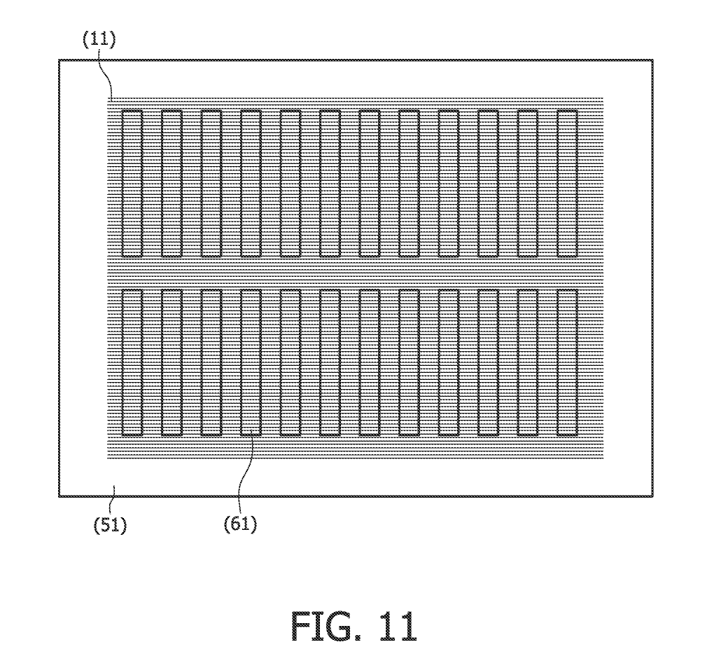

FIG. 3 shows a modal intensity distribution of the fundamental R-polarized mode in a wire grid waveguide with a width W=500 nm. In an approach, as only zero order diffraction occurs, the planar structures can be replaced by a uniform layer having an permittivity equal to the average of the permittivity of the water and the aluminium (for a duty cycle of 50%): ncladding=0.117−j*5.39. For the approximate slab structure thus consisting of 5 layers, the waveguide modes can be calculated. The modal intensity distribution resembles the modal distribution of a conventional (by total internal reflection) optical waveguide.

FIG. 4 shows an estimation of the attainable propagation length for R-polarized light by calculation of the decay length (corresponding with (1/e)̂2 of the input power) of the fundamental mode for varying wave-guide widths W. A vertical line indicates the diffraction limited wave-guide width (250 nm). The decay roughly varies linearly on a log-log scale for wave-guide width above the diffraction limited width and drops rapidly for wave-guide widths below the diffraction limited width. Depending on the application, one needs for example decay lengths of 100 μm (e.g., local excitation of fluorophores) in combination with small waveguide widths up to decay lengths of 1 cm for transporting the light over a chip. FIG. 6 shows that a proper choice of the wave-guide width results in solutions for both cases:

1. Waveguide width of 0.4 micrometer results in decay length of 100 μm.
2. Waveguide width larger than 2 micrometer results in decay length of more than 1 cm.

FIG. 1 describes a waveguide 1 formed with two wiregrids 14, 15 as an embodiment of the invention. Even though this invention can be used generally in many applications, the embodiments referenced in FIG. 5-FIG. 8 will be described as further embodiments in a biosensor application. Thus, the waveguide 1 as indicated in FIG. 1 is provided in luminescence sensor 500. Although alternatives are possible, in a preferred embodiment, this sensor 500 is arranged to have a fluid flowing from the top->bottom and visa versa (vertical flow through scenario).

FIG. 5 shows a sensor arrangement 500 comprising a wire grid waveguide 1 for fluorescence excitation 201, 202. The sensor arrangement 500 is embedded into a container/cuvette (30) filled with a fluid 12 (e.g. water). The wiregrid waveguide 1 is permeable for a water flow transverse to a plane defined by the planar structures 14, 15. Detectors 21, 22 are arranged to receive luminescent radiation 202 from a luminophore 10b from a direction transverse to the planar structures 14, 15.

The fluid also contains luminescent beads (10a-c) that are evidence of e.g., DNA. In this embodiment R-polarized (with respect to the planar structures) excitation radiation (101) from a radiation source (not shown) is coupled in from the left of the cuvette (30) exciting one or more modes (102) of the wire-grid waveguide. The R-polarized excitation radiation is confined between the planar structures (1). The amount of excitation radiation below and above the wire grid is very low since a transmission of R-polarized per reflection is about 0.002%. This implies that the beads above (10a) and below (10c) the wire grid wave guide will essentially not be excited and accordingly will essentially not contribute to a detected luminescence. The bead (10b) in between the planar structures (1) is probed by the waveguide mode(s) (102) which results in a luminescent signal. The orientation of the transition dipole moment beads in a fluid 12 is in general random both in time and space, which implies that about 50% of the luminescent signal is R-polarized (201) and 50% of the luminescence signal is T-polarized (202); for an ensemble of beads with random transition dipoles, and no depolarization, it can be demonstrated that a fraction ⅗ of the generated fluorescence has the same polarization as the excitation light, but in the remainder of this document we assume that 50% of the luminescent signal has the same polarization as the excitation light. The R-polarized light cannot escape the wire grid waveguide and is coupled to the modes of the wire grid waveguide. Using detectors (PMT, APD, CCD array, . . . ) above (21) and below (22) the wire grid wave guide, the T-polarized fluorescence transmitted through the apertures of the wiregrid structure 14, 15 can be detected (202) by detectors 21, 22 respectively. The remaining excitation radiation (103) couples out at the exit of the wire grid waveguide (which may in addition or alternatively also be detected, see FIG. 6).

An upper or lower detector 21, 22 may be replaced by a mirror to reduce the number of detectors. The mirror reflects the luminescence back towards the wire grid waveguide. Because the wire grid waveguide is transparent for T-polarized light, the wire grid crosses through wire grid waveguide and reaches the remaining detector. Alternatively, one of the detectors may be left out completely, without replacing it with a mirror.

FIG. 6 shows an embodiment wherein R-polarized luminescence is detected in addition to the detected T-polarized luminescence, by detectors 24.

The R-polarized luminescence is confined between the planar structures 14, 15 of the wire grid waveguide, and coupled to the modes of the wire grid waveguide. By putting a detector (24) and wavelength filter (25) (that suppresses the excitation radiation (103)) at the exit side of the wire-grid waveguide one can detect (at least part of) the R-polarized luminescence that is coupled into the wave guide (203).

As an alternative one of the planar structures 14, 15 are replaced by an array of 2D sub-diffraction limited apertures, also referenced as a pin-hole structure 150. In particular, in this embodiment, the apertures define a largest in plane aperture dimension being smaller than the diffraction limit, which confines the fluorescence 202 in two planar dimensions. Accordingly one can replace one (or both) of the planar structures by an array of 2D sub-diffraction limited apertures; these arrays have a high reflection (and evanescent fields inside the apertures) for both polarizations. In the shown embodiment of FIG. 6, wire grid 15 is replaced by an array of 2D sub-diffraction limited apertures: In this case only one detector 21 is needed. In that case the wave guide 1 (with a wire grid 14 and 2D sub-diffraction limited aperture arrays 15 as mirrors) still confines R-light 201 only. The T-polarized light 202 can still escape from the wave guide through the wire grid 14. An advantage of this configuration is that the array of 2D sub-diffraction limited apertures acts as a mirror for the R-polarized fluorescence 202, which implies that the luminescence exits the wave guide 1 only through the wire grid 14 and as a consequence one detector 21 is sufficient for detecting the R-polarized luminescence.

Alternatively, both wire grids may be replaced by arrays of 2D sub-diffraction limited apertures, thus functioning as a wave guide for both polarizations. In that case the wave guide fluorescence 201, 202 can now be detected similar to the configuration of embodiment 4. An advantage of this configuration is that both R- and T-polarized luminescent radiation can be detected by the same detector.

FIG. 7 shows an embodiment wherein the planar structures 14, 15 are provided on a substrate 13. In particular, the planar structures 14 and/or array of sub-diffraction limited pinholes 15 are positioned on a (glass) substrate 13 which is not permeable for the fluid anymore. In this embodiment, without additional openings in the substrate, a vertical flow through is prevented, so this requires pumping of the fluid in the same direction (left to right and/or visa versa) as the excitation radiation. The embodiment shows an improved mechanical strength of planar structures on substrate compared with freestanding planar structures. By putting a mirror (not shown) with low reflection for the excitation radiation 101 and high reflection for the fluorescence 201, one can prevent said excitation radiation 101 from being detected and redirect the R-polarized luminescence 201 that propagates towards the entrance and detect by detector 21 or 22.

FIG. 8 shows an embodiment where the excitation radiation is enhanced. To this end the wave guide comprising a reflector (41, 42) to reflect the propagating wave in a propagation direction in the wave guide 1. In one embodiment, (one of the) reflector(s) (41, 42) is selectively transmissive for radiation of a wavelength differing from said propagating wave. This can be used for detecting luminescence through the mirror. In particular, by putting mirrors (41,42) with high reflectivity for the excitation radiation 101 (typically better than 90%) at the input and output facets of the wave guide system, one can build a Fabry-Perot cavity for the excitation radiation. This can result in an enhancement of the excitation radiation. One can use broadband mirrors in which case probably both the excitation and the luminescence light will be reflected, which has the disadvantage the detection of the R-polarized fluorescence is impaired by the cavity. As alternative one can think of using narrow band mirrors (e.g., multilayer mirrors) that have reasonably high reflection for the excitation radiation and low reflection for the luminescence.

Another possible configuration is to use a broadband mirror on the entrance and on the exit side a narrow band mirror with high reflectivity for the excitation radiation and not for the luminescence. As a result we still have enhancement and the R-polarized luminescence initially traveling to the left is redirected to the right hand side of the wave-guide 1. An advantage of this configuration is that one can use a single detector (at the exit side, detector is not shown here) for detecting the R-polarized luminescence and still enhance the excitation field. Another possible configuration only uses one mirror placed on the exit side of the waveguide. The advantage of this configuration is that the excitation radiation that would normally exit the waveguide, is now redirected into the waveguide, effectively doubling the energy of the excitation radiation. This configuration is not as efficient as two mirrors, but it will still achieve an improvement, and is much easier to align and use.

FIG. 9 shows an embodiment wherein a confining medium 32 is comprised between said planar structures 14, 15 to confine said propagating wave 101 (see FIG. 8) in a region confined in a direction transverse to a propagation direction in said wave guide 1 so that the light is confined in direction A-A as indicated in FIG. 9. Preferably a spacer material 32 is provided and subsequently patterned into a channel 31 in between two planar structures 14, 15. When the index of refraction of the spacer material 32 is lower than the index of refraction of the fluid 12, then the light experiences total internal reflection at the interface between the fluid 12 and the spacer materials 32, and as a consequence the light is confined in the direction A-A as well. As an example of an appropriate spacer material TEFLON can be used.

FIG. 10 shows an embodiment of free-standing wire grid devices according to an embodiment of the invention, showing a pressure dependent behaviour of a free standing wire 11 supported by supporting structures 51. This configuration for free-standing wire grid devices can reduce the bending of the stripes 11 of the freestanding wire grid and is less fragile.

When flowing fluid through a freestanding wire grid 1 (see FIG. 5) or when handling a free standing wire grid structure a pressure difference (and force) will be applied to the wire grid 1. This pressure difference results in bending of the strips 11 of the wire grid 1. In FIG. 10 a case is considered of a laminar flow through a cylindrical hole with a hole diameter 2R=100 nm and a depth T=100 nm. Taking into account shear forces and a given pressure difference (ΔP) results in an analytical expression for the velocity distribution (v) and the flow through a single hole (φ):

$$v ( r ) = \frac{Δ P}{4 η T} ( {R}^{2} - {r}^{2} ) \\ φ = \frac{Δ P}{8 η T} π {R}^{4} \qquad ( 2 )$$

For the above described hole this results in flow (for water having a viscosity of η=0.008904 poise) per unit pressure difference of: φ/ΔP=2.76×10⁻²¹ m³/(Pa·s). As an example for a bead to remain 1 second in a hole, a volumetric flow of φ=7.9×10⁻²² m³/s and a pressure difference of only 0.3 Pa is sufficient. For a measurement time (per bead) of 1 ms preferably a pressure difference of 300 Pa is applied.

In order to calculate the bending of the wire grid, FIG. 10 shows a wire grid with length L; depth T=100 nm and width of the strip of W=100 nm for a uniform pressure difference and Aluminium as material of the strip 11; having a modulus of elasticity, E=7×10¹⁰ N/m².

FIG. 11 shows a configuration whereby mechanical stability of free-standing wire grids can be provided while still having an acceptable area for flow-through. In particular, the wire grids 11 define slitted apertures in a planar structure 51, the grids 11 being supported on a substrate 51 wherein slots 61 are provided. The slots 61 are oriented transverse, preferably perpendicular to the wire grids 11.

Accordingly, the wire grids 11 are supported on a permeable structure that by itself can withstand a flow pressure. The slots 61 are provided in support structure 51 with long but narrow openings. The slots can be 100 microns or more and are typically a few microns wide provided in the supporting structure (51).

Alternatively, the slots are a few microns long in both planar directions. By closely packing of the slots, a membrane structure is provided with micron sized pores.

While the invention has been illustrated and described in detail in the drawings and foregoing description, such illustration and description are to be considered illustrative or exemplary and not restrictive; the invention is not limited to the disclosed embodiments.

In one example, other adjacent media are used, in particular, of a refractive index smaller than the media 12.

For example, it is possible to operate the invention in an embodiment wherein fluorescence is used as a marker or as a tracer for biomedical purposes.

The aforementioned embodiments were dealing with luminescent particles. However, other kind of particles can be used that interact with the excitation light resulting in absorption and/or scattering of the excitation light. In particular, the scattering by particles in the wave guiding medium such as metal nanoparticles with diameters between 1 and 100 nm can be measured. In this case, the R-polarized excitation light propagating in the waveguide is scattered by the particle. The T-polarized component of the scattered radiation, for example, can be detected through the apertures of the planar structures 14, 15. The absorption by particles in the wave guiding medium results in a decrease of the power of the excitation light propagating through the wave guiding structure. This reduction in power can be determined by measuring the power of the light propagating through the waveguide.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A wave guide (1) comprising:
a wave guiding medium (12) defining a diffraction limit for a wave to be guided in said wave guiding medium, having an index of refraction and provided between first and second wave reflecting planar structures; wherein
at least said first planar structure (14, 15) forms a plurality of apertures having a smallest in plane aperture dimension smaller than the diffraction limit; and wherein
said first planar structure (14) is arranged between said wave guiding medium (12) and an adjacent medium (12) having an index of refraction equal or larger than the wave guiding medium.

2. A wave guide according to claim 1, wherein said apertures define a largest in plane aperture dimension; wherein said largest in plane aperture dimension is smaller than the diffraction limit.

3. A wave guide according to claim 1, wherein said apertures define a largest in plane aperture dimension; wherein said largest in plane aperture dimension is larger than the diffraction limit.

4. A wave guide according to claim 3, wherein said second planar structure forms a plurality of second apertures defining a smallest second in plane aperture dimension; wherein said smallest second in plane aperture dimension is smaller than the diffraction limit.

5. A wave guide according to claim 4, wherein said second apertures define a largest second in plane aperture dimension; wherein said largest second in plane aperture dimension is larger than the diffraction limit and provided parallel to said largest first in plane aperture dimension.

6. A wave guide according to claim 1, wherein said planar structures forming said apertures, comprise a non-transparent medium provided on a substrate (13).

7. A wave guide according to claim 6, wherein said wave guiding medium (12) equals said adjacent medium to form a surrounding medium (12); and wherein said substrate (13) is permeable to said surrounding medium to provide a free planar structure supported by said substrate.

8. A wave guide according to claim 7, wherein said apertures in said planar structure define a largest in plane aperture dimension and wherein slots (61) are provided in said substrate defining a largest slot dimension oriented transverse to the largest aperture dimension and supporting the planar structure (14, 15).

9. A wave guide according to claim 7, wherein a medium feed unit is arranged to feed said medium in a direction transverse relative to said planar structure.

10. A wave guide according to claim 1, further comprising a confining medium (32) to confine said propagating wave (101) in a region confined in a direction transverse to a propagation direction in said wave guide.

11. A wave guide according to claim 1, further comprising a reflector (41, 42) to reflect said propagating wave (101) in a propagation direction in said wave guide (1).

12. A wave guide according to claim 11, wherein said reflector (41, 42) is selectively transmissive for radiation (201) of a wavelength differing from said propagating wave.

13. A sensor (500) comprising a waveguide (1) according to claim 1, and further comprising:
a radiation source arranged to provide excitation radiation (101) to propagate through said waveguide; and
a detector (21, 22) arranged to receive radiation (201, 202) from a particle (10b) that interacts with said excitation radiation (101) in said waveguide (1).

14. A luminescence sensor (500) according to claim 13.

15. A luminescence sensor according to claim 14, said waveguide being permeable for a medium feed flow (12) transverse to said planar structure (14, 15); the medium comprising a luminophore (10a, 10b, 10c); and said detector (21, 22) arranged to receive luminescent radiation from said luminophore from a direction transverse to said planar structure.

16. A luminescence sensor according to claim 14, arranged to provide a medium feed flow parallel to said planar structure (14, 15); the medium (12) comprising a luminophore (10b); and said detector (24) arranged to receive luminescent radiation (201) from said lumiophore in a direction parallel to said planar structure.

17. A luminescence sensor according to claim 16, said detector being provided with an excitation radiation blocker (25).

18. A method of detecting a presence of a luminophore in a wave guide, comprising:
propagating excitation radiation (101) in a wave guide (1) comprising a wave guiding medium (12) defining a diffraction limit for excitation radiation to be guided in said wave guide (1), having an index of refraction and provided between first and second reflective planar structures (14, 15) constructed and arranged to reflect said wave (101) in said wave guiding medium (12); at least one of said planar structures comprising an aperture defining a smallest in plane dimension smaller than the diffraction limit;
providing a luminophore in a said wave guide medium (12), the luminophore (10a, 10b, 10c) being excitable by said excitation radiation (101) to emit luminescent radiation (202); and
detecting said luminescent radiation (202) by a detector (21).

19. A method according to claim 18, wherein said luminescent radiation (202) is detected through said aperture of said planar structure (14, 15).

20. A method according to claim 18, wherein said aperture defines a largest in plane aperture dimension; wherein said largest in plane aperture dimension is larger than the diffraction limit.

21. A method according to claim 18, further comprising preventing said excitation radiation (101) from being detected.

22. A method according to claim 18, wherein said luminophore is provided in a fluid medium; said planar structure (14, 15) being permeable by said fluid medium (12), and said method further comprising feeding said fluid medium in a flow through said planar structure; and detecting luminescent radiation (202) from said luminophore (10b) from a direction transverse to said planar structure (21).

23. A method according to claim 18, wherein said luminophore is provided in a fluid medium (12); said planar structure being permeable by said fluid medium, and said method further comprising feeding said fluid medium in a flow parallel to said planar structure; and detecting luminescent radiation from said luminophore from a direction parallel to said planar structure.

24. A method according to claim 18, wherein said luminophore is arranged to bind with a biomolecule.
